(19) United States
(12) Patent Application Publication
(10) Pub. No.: US 2014/0200072 A1
(43) Pub. Date: Jul. 17, 2014

(54) METHOD AND SYSTEM FOR PROVIDING AGGREGATED WAGERING EVENT PICK INFORMATION TO BETTORS

(71) Applicant: Ronald J. Tassinari, Las Vegas, NV (US)

(72) Inventor: Ronald J. Tassinari, Las Vegas, NV (US)

(21) Appl. No.: 14/156,743

(22) Filed: Jan. 16, 2014

Related U.S. Application Data
(60) Provisional application No. 61/753,748, filed on Jan. 17, 2013.

(51) Int. Cl. G07F 17/32

(52) U.S. Cl. CPC G07F 17/3288
USPC 463/25

(57) ABSTRACT

A method and system are provided by which individual sports event wagering pick information, such as multiple handicapper picks, are collected and aggregated. The aggregated information which was obtained from multiple sources is then provided at a single location and form to a bettor. The method and system has particular applicability to sports event wagering, wherein a plurality of handicapper picks of the winning bets for a sports event are collected and aggregated, giving a bettor a set of data with higher statistical stability and probability.

### RELATED APPLICATION DATA

This application claims priority to U.S. Provisional Application Ser. No. 61/753,748, filed Jan. 17, 2013.

### FIELD OF THE INVENTION

The present invention relates to systems for providing information relating to wagering events.

### BACKGROUND OF THE INVENTION

Sports event wagering is the single largest type of wagering with estimates that billions of dollars are wagered each year. Different types of sports event wagers are offered. For example, a bettor may wager whether the total score of a sports event will be above or below a particular level. A bettor may wager that a particular sports event participant will win the event or will win the event by more than a particular number of points or the like. In all cases, however, the goal of the bettor is to attempt to place a winning wager upon the wagering event. For example, relative to football games, a bettor will place a wager on the team that the bettor believes will be the outright winner of the game or will be the winner based upon the points spread which is assigned in the wagering event.

Part of the allure of sports event wagering is the perceived skill involved in determining the probable winner of the event. Each bettor may use entirely different information or criteria in making their bets. For example, bettors may look at historical game results, current athlete injuries, game location, weather and other information, as well as utilize their “gut feel” in order to make their selections.

For example, one source of sports event wagering information which bettors may encounter is handicapper picks. Newspapers often have sports reporters who offer one or more sports wagering picks to bettors. These picks serve as an enticement for bettors to read the newspaper to gain addition information or insight into betting options. Other handicappers offer their picks based upon a paid service. A bettor may pay a fee to the handicapper to purchase the handicapper's picks, such as the handicapper's picks of the winners for each week's pro football games.

Ultimately, a large quantity of information exists regarding sports events which a bettor might attempt to locate and use in placing their wagers. However, this information is disjointed and may be found on the Internet, newspapers, trade industry papers and newsletters, radio, television and from other sources. In addition, the information may range from player and team statistics, injury reports and the like. In general, most bettors believe that having more information at their disposal enables them to make more informed sports event wagers. Unfortunately, however, the average bettor does not have the time or resources to locate so many disparate sources of information and to review, collate and compile such a large amount of information.

### SUMMARY OF THE INVENTION

Embodiments of the invention comprise methods and systems aggregating wagering event “picks” from two or more sources and providing that aggregated information to one or more bettors. In a preferred embodiment, the method and system has particular applicability to sports event wagering events, wherein handicapper picks for such wagering events are aggregated and the aggregated information is provided to bettor in a succinct, organized and orderly fashion.

In one embodiment of a method, two or more sports event wager picks are obtained from different sources. The sources might comprise, for example, websites which present information regarding handicapper picks. However, the sources might comprise magazines, newspapers, blogs or other sources.

The sports event wager picks from the two or more sources are aggregated, such as by combining the information, to generate aggregated sports event wager pick information. This aggregated information is then presented to a bettor, such as via a single website.

In one embodiment of a system, an aggregate information server receives the source information. For example, the aggregate information server might obtain information from different servers which support different handicapper websites. Alternatively, the source information might be input to the aggregate information server via a connected computer, such as a user station.

The aggregate information server preferably stores the source information and then generates the aggregate information, such as using machine-executable instructions (e.g., software). The software may, for example, sum the source information, generate percentage information or the like. The aggregated information may be presented by the aggregate information server, such as via a website.

As one example of the invention, handicapper picks of the probable outcome of a wager upon a football game (which wagering event may comprise the selection of the outright winner or the winner based upon the line or spread on the game) are gathered from different sources. The individual handicapper picks are aggregated, such as to provide information regarding the percentage of handicappers picking particular outcomes of the event. This aggregated information is then presented to a bettor via a single source, such as a single website.

Further objects, features, and advantages of the present invention over the prior art will become apparent from the detailed description of the drawings which follows, when considered with the attached figures.

### DESCRIPTION OF THE DRAWINGS

FIG. 1 schematically illustrates a system in accordance with an embodiment of the invention;

FIG. 2 illustrates aggregated wagering event pick information which may be presented to a bettor in accordance with an embodiment of the invention; and

FIG. 3 illustrates underlying wagering event pick information which may be displayed to a bettor in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods and systems aggregating wagering event “picks” from two or more sources and providing that aggregated information to one or more bettors. In a preferred embodiment, the method and system has particular applicability to sports event wagering events, wherein handicapper picks for such wagering events are aggregated and the aggregated information is provided to bettors.

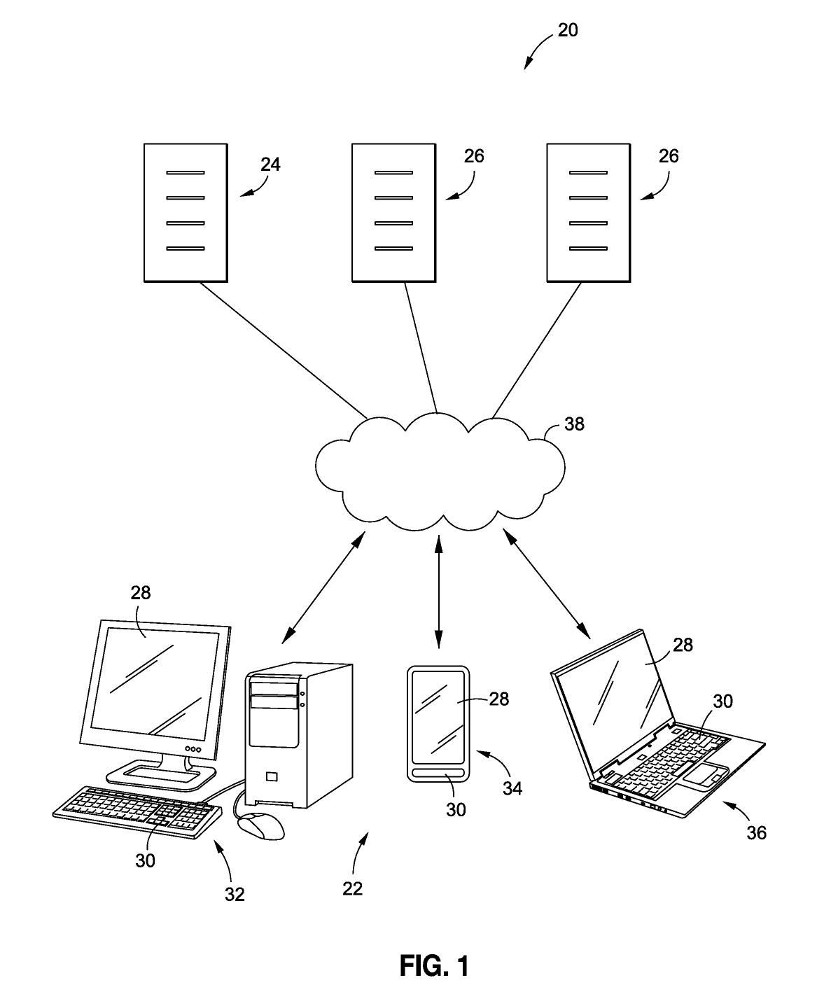

As illustrated in FIG. 1, in one embodiment, an information system 20 comprises one or more presentation devices 22 (it being understood that while there may be two or more presentation devices 22, for convenience herein, the system is primarily described relative to a bettor's use of a “presentation device 22”), one or more aggregate information servers 24 (it being understood that while there may be two or more aggregate information servers 24, for convenience herein, the system 20 is primarily described relative to a single “aggregate information server 24”), and one or more information sources, such as source information servers 26.

The presentation device 22 may be a dedicated/special purpose device or may be a general purpose device. The presentation device 22 is preferably an electronic device, and more preferably a computing device. The presentation device 22 may include at least one video display 28 capable of displaying game information, at least one input device 30, and at least one communication interface.

The presentation device 22 might comprise, for example, a desktop computer 32, a telephone (including cellular, wireless or wired telephones) or PDA 34 (such as an iPhone®), a laptop or notebook computer 36, or various other devices. As indicated, the presentation device 22 might also comprise a special purpose device such as a specially configured gaming tablet.

The input device 30 might comprise, for example, a keyboard, mouse, joystick, touch-screen, button(s), track-balls or other devices now known or later configured and which are capable of receiving input from a player. The communication interface is preferably configured to permit information or data to be exchanged from one or more remote device or locations with the presentation device 22. The one or more communication interface might support wired or wireless communications using various protocols. For example, if the presentation device 22 is a PDA, the communications might be by 3G, 4G, IMT, GSM or the like. If the presentation device 22 is a desktop computer, the communications might be by TCP/IP or the like. Of course, other protocols may be used such as Bluetooth, 802.11xx and the like.

It will be appreciated that the presentation device 22 may include other components. For example, the presentation device 22 may include a main processor, a video and/or audio processor, input and output ports or the like.

The aggregate information server 24 is preferably configured to receive information regarding sports event wager picks from a plurality of different sources, to generate aggregated sports event wager pick information, and to present such aggregated sports event wager pick information to a bettor via a presentation device 22.

In one embodiment, the aggregate information server 24 comprises means for receiving source information, means for generating aggregated information and means for presenting aggregated information. Such means may comprise at least one processor. The processor is configured generate aggregated information based upon the input of source information, such as based upon the execution of machine readable game code (i.e. software). Of course, the processor could also be pre-programmed or configured as hardware configured to generate such game data.

In one embodiment, the aggregate information server 24 includes means for storing machine-readable code or instructions. Such means may comprise one or more memory devices. Such might comprise RAM, ROM (including EPROM, EEPROM, PROM) or other devices now known or later developed. The aggregate information server 24 might include one or more other memory devices, such as for storing game state information or the like, as detailed below. In one embodiment, the aggregate information server 24 might comprise or be in communication with one or more mass data storage devices, such as one or more hard drives or the like.

The one or more information storage or “memory” devices are also preferably used to store source information which is obtained from one or more external sources. As indicated below, such source information may comprise one or more sports event wager picks or selections by third parties.

The aggregate information server 24 might also include one or more user interface features. Such might comprise, for example, a user station which includes a video display and one or input devices (such as a keyboard, mouse or the like). Such a user station may permit an operator to interface with and manage or control the aggregate information server 24, such as to change operator settings and the like, and/or to manually input source information.

It will be appreciated that the aggregate information server 24 might comprise more than one device. For example, the aggregate information server 24 might comprise a router and one or more separate computing devices. The functions of the various computing devices might be segregated. For example, one computing device might save and verify login information (as detailed below), while another might monitor game play via the gaming devices.

As described in more detail below, at one or more times a presentation device 22 and the aggregate information server 24 are linked by a communication link. In this regard, the aggregate information server 24 also preferably includes at least one communication interface which facilitates such communications. The type of communication interface(s) and link(s) may vary, such as depending upon the particular type of presentation device 22 and/or the communication path or protocol which is utilized.

In one embodiment, the presentation device 22 and the aggregate information server 24 may communicate through at least one network 38. Such a network might comprise a public and/or private network, including the Internet, a cellular network, a satellite communication network or the like. The network may comprise wired and/or wireless links or pathways. Of course, the communication link might comprise a dedicated link, such as a dedicated wired link between the devices. Further, the communication link might comprise a number of local, wide area or other networks or pathways linked together.

As indicated above, the system 20 preferably also includes or links to one or more information sources. As indicated, such sources might comprise source information servers 26. The source information server 26 might comprise a computing device which has a processor for executing instructions, a memory for storing data such as instructions, and at least one communication interface. In one embodiment, the source information server 26 is configured to provide source information, such as one or more sports event wager picks or selections. For example, the source information server 26 might comprise a web server which is configured to host a website.

Preferably, the aggregate information server 24 is configured to receive information from the source information server 26 at one or more times. Again, such a communication link may have various forms.

The system 20 of the invention may further comprise other systems and components.

In one embodiment of a method and system of the invention, information regarding two more sports event wager picks or selections is aggregated and then aggregated information is presented to one or more bettors.

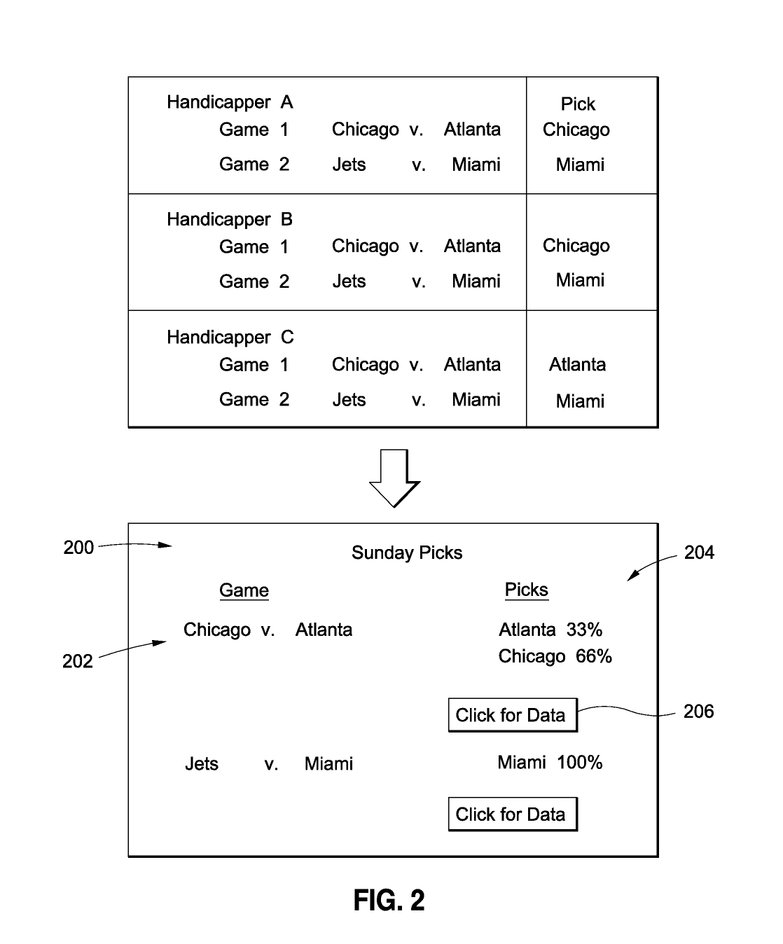

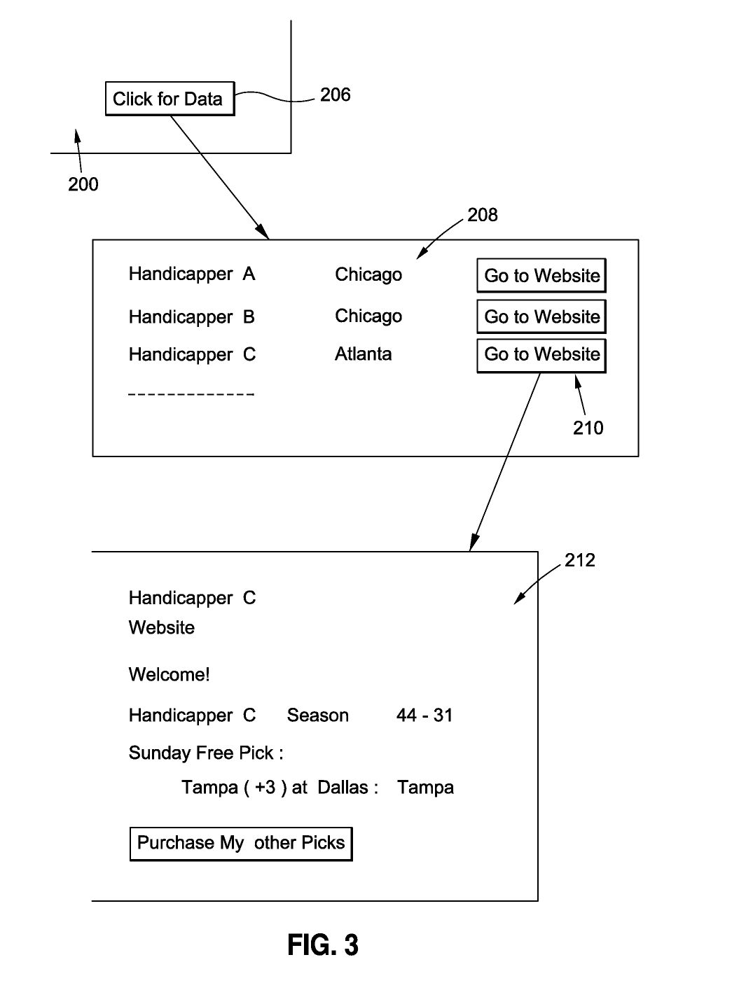

One example of the invention will be described with reference to FIGS. 2 and 3. As illustrated in FIG. 2, information regarding sports event wager picks or selections is provided by two or more sources. As one example, Handicappers A, B and C may each provide sports event wager picks or selections. The picks or selections by these handicappers may be provided in various ways. For example, in one embodiment, this source information may be provided via one or more source information servers 26. As one example, Handicapper A may post sports event wager picks at a first website which is enabled by a first source information server 26. Handicapper B may post sports event wagering picks at a second website which is enable by the same or a different source information server 26. Handicapper C may similarly post sports event wagering picks at a third website, etc.

In such a configuration, the source sports event wager pick or selection information may be provided by exchanging the information between the source information servers 26 and the aggregate information server 24. For example, at one or more times or intervals the aggregate information server 24 might poll the source information server(s) 26 for the latest source information. The source information servers 26 may transmit the information over one or more communication links to the aggregate information server 24.

Of course, the source information might be provided to or be obtained by the aggregate information server 24 in other manners. For example, in one embodiment, the information sources might transmit the information to the aggregate information server 24 from a presentation device 22, such as a computer (rather than from a server). In one embodiment, the source information might be manually input to the aggregate information server 24. For example, an operator of the aggregate information server 24 might view source information (such as from a website, newspaper, blog or the like) and then manually enter the source information to the server 24, such as via a workstation coupled to the server.

In the example illustrated in FIG. 2, three information sources are illustrated. It will be appreciated that there might be fewer information sources or a greater number of information sources. In fact, the invention is particularly suited or applicable to a large number of information sources.

Preferably, the information sources are independent. However, one or more information sources might be the same. For example, information from Handicappers A and B might be obtained from a single website or source, while information from Handicapper C is obtained from a different website or source.

As indicated above, the source information is provided to the aggregate information server 24. The aggregate information server 24 preferably aggregates or combines the source information to generate an output. In one embodiment, the aggregate information server 24 aggregates information regarding sports event wager picks or selections and generates and provides aggregate sports event wagering pick or selection information.

For example as illustrated in FIG. 2, information has been obtained from three sources regarding picks or selections for wagers upon the sports event comprising a professional football game between Chicago and Atlanta. As illustrated, the pick or selection information comprises “Chicago” for Handicapper A, “Chicago” for Handicapper B, and “Atlanta” for Handicapper C.

This information may be stored at or in association with the aggregate information server 24. In one embodiment, the aggregate information server 24 aggregates the pick or selection information to provide information regarding the average pick or selection information, such as the percentage of the picks. For example, the aggregate information server 24 may aggregate the example pick information to generate aggregate information which indicates that for the particular sports event (Chicago vs. Atlanta), Atlanta is picked 33% (i.e. by 1 out of the 3 sources) and Chicago is picked 66% (i.e. by 2 out of the 3 sources) by the sources.

Likewise, in the example illustrated, information has been collected from a plurality of information sources regarding picks or selections for the sports event comprising a football game between the Jets and Miami. In this case, the aggregate information server 24 has generated information which indicates that Miami has been selected 100% of the time.

Of course, the aggregated information may be stored, such as at a memory or data storage device of the aggregate information server 24.

In one embodiment, the aggregate information server 24 provides the aggregated sports event wagering pick or selection information. For example, the aggregated information might be provided via a website which is supported by the aggregate information server 24.

As one example, a user of presentation device 22 might access a website which is supported by the aggregate information server 24 (directly or indirectly). In response to contacting the website, the serer 24 may be configured to transmit responsive data which causes website information to be displayed on a web browser of the user's presentation device 22.

As another example, a user might be required to obtain and install an “app” on their presentation device 22. In one configuration, the user might obtain the application for free. In other embodiments, the user might be required to pay to obtain the application, such as via a one-time purchase fee or a periodic fee. As one example, the application might comprise a software application which is configured for the Apple iPhone® personal electronic device. Such an application might have various user-configurable settings and might be configured to automatically gather aggregated information from the aggregate information server 24. As one example, a user might pay a $2.00 per month fee to download and utilize such an application on their presentation device 22. The user might customize the application to obtain and display aggregated college football game pick information each Wednesday for the upcoming weekend's games. The application may be configured to utilize the communication interface of the presentation device 22 to form a communication link with the aggregated information server 24 and download the aggregated college football game pick information. In such a configuration, the application may perform a “handshake” or log-in sequence with the aggregated information server 24 which verifies the user's subscription to the application is up to date before obtaining the information for the user.

FIG. 2 illustrates an example graphical user interface 200 which may be displayed upon a presentation device 22 when a bettor contacts the aggregate information website (either via an application or a web browser). As illustrated, the graphical user interface may include information which identifies a particular sports event 202, such as a football game between Chicago and Atlanta, and aggregated wagering pick or selection information 204.

In one embodiment, the provided information might include aggregated information regarding more than one sports event. For example, as illustrated, information might be provided regarding additional football games, such as the game between NY Jets and Miami.

Of course, a wide variety of information might be presented and the format of the information may vary.

In a preferred embodiment of the invention, the method comprises presenting aggregated Information—i.e. information which is generated from underlying source information but which is presented in a different form than the source information. As one aspect of the invention, the method and system may be configured to present underlying source information as well.

For example, referring to FIG. 2, a bettor might be permitted to request additional information regarding particular aggregated information. As illustrated, the graphical user interface or website includes a “Click for Data” button 206 relative to one or more displays of aggregated information.

Referring to FIG. 3, if a bettor makes such a request or selection, the aggregate information server 24 may be configured to display underlying source information which was used to generate the aggregated information. As illustrated, a new window or interface of information may be presented. Such information may include the source information for the aggregated information.

In this example, the bettor sought additional information regarding the aggregated pick or selection information for the Chicago vs. Atlanta game. As illustrated, a new window 208 of information was displayed. In this example, the presented information comprises the source information, namely the underlying picks or selections by the handicappers which were used to generate the source information. Of course, this information could vary, such as depending upon the source information which was used to generate the aggregated information.

In one embodiment, a bettor might also be able to access specific information regarding each element of source information. For example, as illustrated in FIG. 3, a “Go to Website” button 210 may be provided relative to one or more of the source information. A bettor's selection of this button 210 may cause the aggregate information server 24 to display additional information to the bettor or to link the bettor to other information. As one example, the selection of such a button 210 might link the bettor to the website from which the source information was obtained. As one example, the bettor might select the button 210 relative to Handicapper C's selection of Atlanta in the Chicago vs. Atlanta game. This might link the bettor to a website which is operated by Handicapper C (or which otherwise provides information regarding Handicapper C and Handicapper C's sports event wagering picks or selections), such as a window or graphical user interface 212 which presents such information. Advertising or similar information might also be provided to the bettor in response to one or more selections.

A variety of aspects of the invention will now be appreciated.

As one aspect of the invention, a method and system combine or aggregate sports event wager picks or selections and present such aggregated information to one or more bettors. Advantageously, a bettor is provided aggregated information, thus providing the bettor with information which is likely to be more accurate, as compared to information from a single source. For example, in accordance with the invention, 100 handicappers might be polled and 99 of 100 of the handicappers might pick Chicago in the game Chicago vs. Atlanta. A bettor who did not use the system of the invention might see the pick by the single handicapper who selected Atlanta and thus believe that Atlanta is a good selection. However, if the bettor had viewed the websites of the other 99 handicappers who all selected Chicago, the bettor would likely have viewed Atlanta as a poor selection. In accordance with the invention, the aggregated information provides a better perspective or better statistical perspective of the best pick.

In addition, in accordance with the present invention, information from multiple sources is aggregated and presented at a single location. Thus, while a bettor might be able to research a number of different sources of information, such as by researching and then reviewing a large number of websites, newspapers and the like, this process is time consuming and tedious. On the other hand, using the system of the present invention, a bettor can obtain aggregated information.

In addition, the aggregated information may relate to various forms of sports event wagers. For example, aggregated information may identify the type of wagering event. As one example, aggregated information might comprise information regarding the predicted outright winner of a sports event, while other aggregated information might be provided for the predicted wagering event winner, such as in cases where the sports event wager has a “line” or “spread”. For example, a particular sports event wager offered by a casino might indicate Chicago (−3) vs. Atlanta. The aggregated pick information may thus identify that the selected winner includes the “spread”. For example, the aggregated pick information might indicate: “Chicago (−3) vs. Atlanta: Chicago 84%, meaning that 84% of the sources believe that Chicago is likely to either win or not lose by more than 3 points (i.e. that betting upon Chicago, taking the 3 points, was the best wager)—i.e. that 84% of the sources believe that picking Chicago is a winning pick on that sports event wager. In a preferred embodiment of the invention, the aggregated information comprises aggregated information regarding the predicted outcomes or “picks” of one or more sports events.

By “picks” or “selections” of sports event wager events it is preferably meant a source's prediction or selection of a winning bet or outcome of the wagering event (as indicated above, such a pick might, depending upon the wagering event, comprise the predicted outright winner of the event or might comprise the winner when considering a line, spread or other variable of the wagering event relative to the sports event). The picks may be made by handicappers. However, the picks might be made by machine prediction or other sources.

As indicated herein, the aggregated information might include a variety of information. For example, the aggregated information might include the number of sources used in the calculation (e.g. Chicago vs. Atlanta: Chicago 67% (121 sources)).

The aggregated information preferably comprises information from two or more sources which is combined to generate a new or modified set of information which does not include the actual display of the underlying individual source information. In one embodiment, the aggregated information might comprise simply the sum of selections for particular sports events (e.g. Chicago v. Atlanta: 16 sources pick Chicago, 4 pick Atlanta); percentages (25% pick A, 75% pick B relative to the event A vs. B), etc. Such information might be presented in various forms, including numerically, graphically, etc.

As indicated herein, the invention has particular applicability to sports events. Of course, such events might comprise football, basketball, soccer, baseball, hockey, horse and auto racing and any of a wide variety of professional or amateur events involving players, teams, animals, cars or the like. In addition, the invention might pertain to other than sports events, such as elections or other events where the outcome is unknown and a wagering event is presented which offers the one or more bettors who correctly predict or guess the outcome, with winnings

While examples have been provided in which two participants were involved in the sports event, the sports event might have multiple participants and thus the aggregated information might include information regarding more than two participants. For example, relative to the NCAA basketball tournament, 64 or more teams participate in the tournament and may thus win the championship. Relative to a sport event wager comprising the selection of the winner of the event, the source information could include picks of any of the teams. Thus, the aggregated information might look like: NCAA tournament winner: North Carolina (32%), Duke (26%), Indiana (23%), UCLA (10%), etc.

Also, while the term “wagering” preferably means an event where monies or monetary value are wagered by a bettor in exchange for the opportunity of being awarded winnings, bettors might wager “for fun”, using points or elements other than money, monetary credits or the like. In addition, while winnings might comprise money or monetary credits, winnings might comprise prizes including free or reduced cost goods or services.

A variety of business models may be used to implement the method and system. For example, in one embodiment of the invention, the aggregated information website may offer aggregated information to bettors free of charge. The website might be funded, for example, from advertisements, including casinos, sports books or other entities which offer sports event wagering which advertise the availability of wagering to bettors at the website. Individual handicappers may be enticed to offer free picks to the aggregate information service in exchange for having their information and/or a link to their website provided at the aggregate information website (as described above, such a link may drive a bettor to the handicapper's website for more information, including purchasing from the handicapper addition of the handicapper's picks). In other embodiments, a bettor might be required to pay a fee for the aggregate information, such as a monthly account fee or a “per pick” free.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of providing aggregated sports event wagering information comprising:
receiving at a computing device information from a first source regarding a first sports event wager pick;
receiving at said computing device information from a second source regarding a second sports event wager pick;
generating, using a processor of said computing device, aggregated sports event wager pick information from said first and second sports event wager picks; and
transmitting said aggregated sports event wager pick information to an electronic presentation device of a bettor.

2. The method in accordance with claim 1 wherein said first and second sports event wager picks comprise handicapper picks of a winner of a football game wagering event.

3. The method in accordance with claim 1 wherein said receiving steps comprise receiving electronic data from a first web server and a second web server.

4. The method in accordance with claim 1 wherein said step of transmitting comprises presenting a website at which said aggregated sports event wager pick information is displayed.

5. The method in accordance with claim 1 wherein said first and second sports event wager picks comprise a pick of a first sports event participant or a second sports event participant and said aggregated sports event wager pick information comprises information regard a percentage of said picks for said first sports event participant or said second sports event participant.

6. The method in accordance with claim 5 wherein said first sports event participant and said second sports event participant comprise football teams.

7. The method in accordance with claim 1 further comprising the step of receiving payment from said bettor before said transmitting step.

8. The method in accordance with claim 1 further comprising transmitting information identifying said first source and said second source to said electronic presentation device of said better.

9. The method in accordance with claim 8 wherein said information identifying said first source and said second source comprises information regarding an identity of a first handicapper comprising said first source and a second handicapper comprising said second source.

10. The method in accordance with claim 1 wherein said first sports event wager pick comprises a pick of a first or second sports event participant based upon a spread and said second sports event wager pick comprises a pick of said first or second sports event participant based upon said spread.

11. A system for providing aggregated sports event wagering information comprising:
at least one aggregated information server, said aggregated information server including at least one communication interface, at least one processor, at least one data storage device and machine-executable code, said server configured to receive data from a first remote source comprising information regarding a first pick of a sports event wagering event via said at least one communication interface, receive data from a second remote source comprising information regarding a second pick of said sports event wagering event via said communication interface, to store said first and second pick information at said at least one data storage device, to generate aggregated pick information for said sports event wagering event from said first and second pick information using said machine-executable code, to store said aggregated pick information and to transmit said aggregated pick information for display at a bettor's electronic communication device via said at least one communication interface.

12. The system in accordance with claim 11 wherein said first remote source comprises a first web server and said second remote source comprises a second web server.

13. The system in accordance with claim 12 wherein said aggregated pick information further comprises links for connecting said first web server and said second web server.

14. The system in accordance with claim 11 wherein said server is configured to generate aggregated pick information in the form of a percentage that a first sports event participant of said sports event is picked from a total of all picks.

15. The system in accordance with claim 11 wherein said first and second picks comprises picks of a first sports event participant or a second sports event participant.

16. The system in accordance with claim 15 wherein said first and second sports event participants comprise football teams.

17. The system in accordance with claim 11 wherein said at least one aggregated information server is configured to process payment from said bettor as payment for receiving said aggregated pick information.
